(19) United States
(12) Patent Application Publication
(10) Pub. No.: US 2006/0224625 A1
(43) Pub. Date: Oct. 5, 2006

(54) Alert method and apparatus for identifying pets available for adoption

(76) Inventor: Chris J. Warner, Scottsdale, AZ (US)

Correspondence Address: BINGHAM MCCUTCHEN LLP, 3000 K STREET, NW, BOX IP, WASHINGTON, DC, 20007, US

(21) Appl. No.: 11/098,386

(22) Filed: Apr. 5, 2005

(51) Int. Cl. G06F 7/00

(52) U.S. Cl. 707/104.1

(57) ABSTRACT

Information about pets presently in shelters or otherwise available for adoption is collected and stored in a centralized database that is accessible through, for example, a website. Each pet may be identified by type, a photograph, a locality where it is located, and other convenient information. Users who wish to locate a nearby pet register with a website and may set up an alert profile describing the type of pet they desire to look for or adopt, a geographic area within which they expect to find the pet, and the type of device on which they would like to receive an alert when a matching pet becomes available. Periodically, the alert profiles are processed and any matching pets within the geographic area defined by the user are identified and sent to each devices specified by the user.

### FIELD OF THE INVENTION

The present invention relates to collecting, storing, retrieving and forwarding information that meets particular criteria and, more particularly, to collecting and storing information on pets and to providing an interface through which users can define pets in a geographic area that they are interested in adopting and thereafter receive alerts when pets meeting certain criteria are found.

### BACKGROUND OF THE INVENTION

There are presently problems associated with locating pets and making pets available for adoption in an efficient and effective manner. The result is that local animal shelters are overburdened with animals and, when a shelter cannot find homes for animals, the shelter is forced to euthanize the animal after a period of time, which can be as short as 48 hours. In the United States of America, upwards of 5 million homeless animals are euthanized each year.

Pets generally reach shelters when they are lost or abandoned. With respect to lost pets, there is no unified system for locating them. Therefore, the owners are often forced to resort to posting pictures in public places or taking out ads in newspapers. While the Internet has provided an additional channel for information distribution, its chaotic nature minimizes the chances that the person who found a lost pet would find the specific posting made by the owner.

This situation is further exacerbated if the lost pet is taken in by an overburdened shelter or rescue organization. Because such organizations may be forced to euthanize animals taken in as little as 48 hours depending on the shelter and its conditions, the likelihood of recovery of a lost pet in general and also when the pet has been taken in by a shelter is unnecessarily low.

With respect to animals in shelters generally, over 75 percent of them are adoptable. Many of these animals are purebred breeds that the public searches for only at pet stores and through breeders, even though they may be available at the local shelter or rescue for a tenth of the cost of a pet store.

Accordingly, there is a need for a new system and method for making information about lost pets available to people who have lost a pet in a timely manner to facilitate recovery. There is a further need for a new system and method for making information about animals that have arrived in a shelter, or that otherwise are ready for adoption, available to those who wish to adopt a pet.

### SUMMARY OF THE INVENTION

According to the present invention, information about pets presently in shelters or otherwise available for adoption is collected and stored in a centralized database that is accessible through, for example, a website. Each pet may be identified by type, a photograph and contact information for the individual or organization boarding the animal. Additional information for each pet may include the name and age of the pet, health conditions, and other characteristics of the animal. Users who wish to locate a nearby pet register with a website. After registration, the user may set up an alert profile describing the type of pet they desire to look for or adopt, a geographic area within which they expect to find the pet, and the type of device on which they would like to receive an alert when a matching pet becomes available. Periodically, the alert profiles are processed and any matching pets within the geographic area defined by the user are identified. Alerts are then sent to each device (i.e. mobile phone, computer, email address) specified by the user when a matching pet is identified within the geographic area defined by the user. This facilitates identifying and recovering lost pets within a geographic area and also facilitates matching individuals looking to adopt a particular type of pet with pets of that type in a geographic area.

According to an embodiment of the present invention, a method for generating pet alerts, includes storing, creating and generating steps. The method stores pet information into a database corresponding to available pets. It then creating alert criteria for a user corresponding to a desired pet. The method further generates an alert transmitted to a device of the user when the desired pet is found in the pet information database. The pet information further comprises information on the location of each pet stored in the database.

### BRIEF DESCSRIPTION OF THE DRAWINGS

The above described features and advantages of the present invention will be more fully appreciated with reference to the detailed description and figures, in which:

FIG. 1 depicts a functional block diagram of a system for collecting information on pets and making the information available for a pet alert process and for other purposes according to an embodiment of the present invention.

FIG. 2 depicts a method of registering a user to receive pet alerts according to an embodiment of the present invention.

FIG. 3 depicts a method of generating alerts according to an embodiment of the present invention.

### DETAILED DESCRIPTION

According to the present invention, information about pets presently in shelters or otherwise available for adoption is collected and stored in a centralized database that is accessible through, for example, a website. Each pet may be identified by type, a photograph and contact information for the individual or organization boarding the animal. Additional information for each pet may include the name and age of the pet, health conditions, and other characteristics of the animal. Users who wish to locate a nearby pet register with a website. After registration, the user may set up an alert profile describing the type of pet they desire to look for or adopt, a geographic area within which they expect to find the pet, and the type of device on which they would like to receive an alert when a matching pet becomes available. Periodically, the alert profiles are processed and any matching pets within the geographic area defined by the user are identified. Alerts are then sent to each device (i.e. mobile phone, computer, email address) specified by the user when a matching pet is identified within the geographic area defined by the user. This facilitates identifying and recovering lost pets within a geographic area and also facilitates matching individuals looking to adopt a particular type of pet with pets of that type in a geographic area.

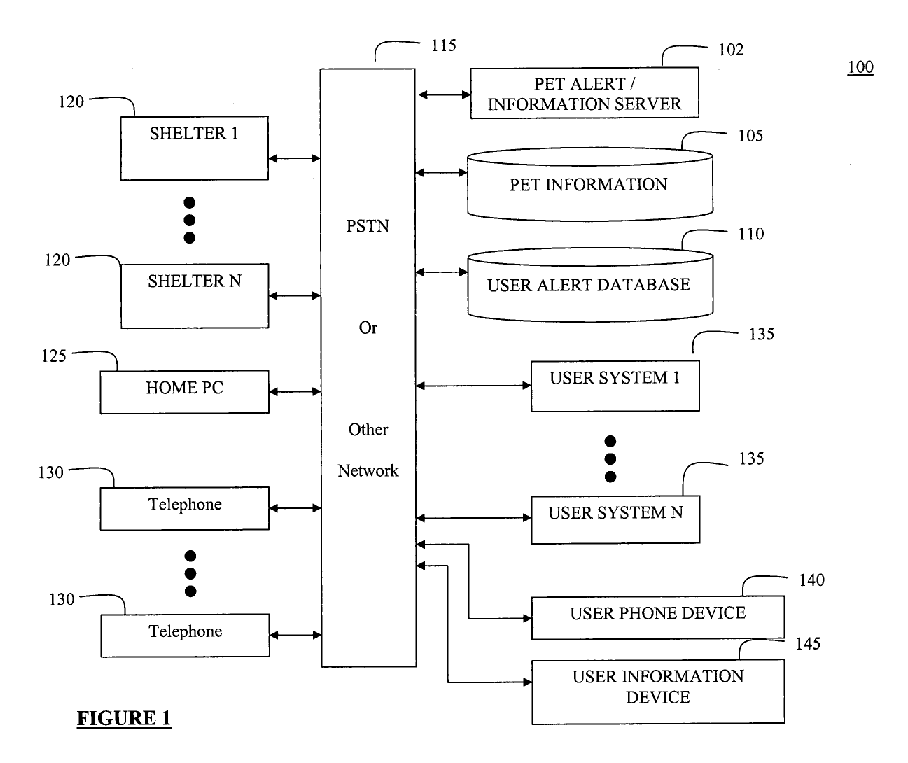

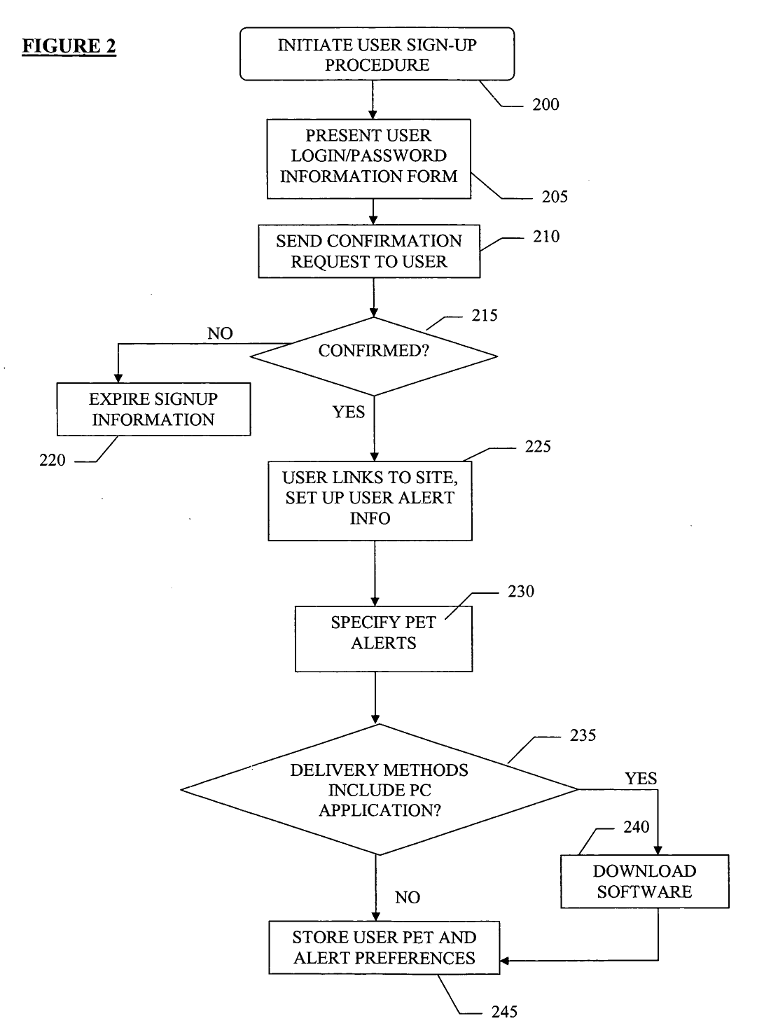

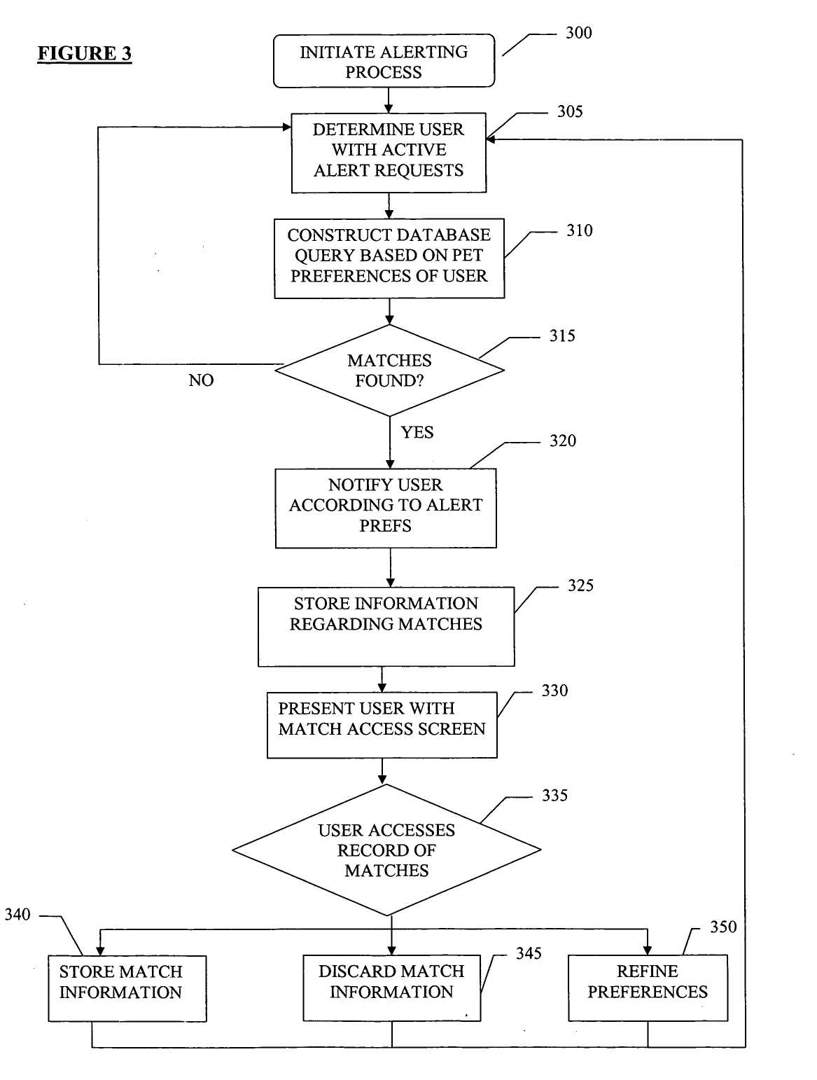

FIG. 1 depicts a functional block diagram of a system 100 for collecting information on pets and making the information available for a pet alert process and for other purposes according to an embodiment of the present invention. FIG. 1 is discussed initially to provide an overview of the different aspects of the system 100 for collecting information and defining and generating alerts. The processes for defining alerts and for generating alerts are discussed in more detail below with reference to FIGS. 2 and 3.

Referring to FIG. 1, pet information is collected and stored in a pet information database 105 coupled to a network 115 via a pet alert/information server 102. Also coupled to the network 115 and used to provide information to the pet database 105 are computers at one or more pet shelters 120, one or more user computers 125, and a plurality of telephones 130. In addition, user systems 135 are coupled to the network 115 to allow users to define pet alerts, to identify lost pets or found pets as discussed further below. In addition, user phone and information devices 140 and 145 may be coupled to the network to receive alerts. A user alert database 110 is used to store user information and alert information defined by users as discussed in more detail below.

The server 102 may be any general purpose computer, including a server, and may be used to facilitate the interaction between shelters, those who have found or recovered animals that need adoption, and users who are looking for information about animals that have been found in order to recover a lost pet or to consider adoption. According to one embodiment of the invention, the server interacts with user and the databases 105 and 110 in order to produce web pages that are accessible over the Internet and in order to carry out off-line processing used in generating the alerts. With respect to the web pages, the server may generate web pages that: (i) allow a user to sign up for pet alerts; (ii) allow a user to browse or search for animals that are available for adoption in particular localities by, for example, zip code; (iii) facilitate reporting lost or found animals in particular localities; and (iv) facilitate providing information on pets available for adoption in particular localities.

The pet information database 105 is a relational database that stored information for each pet in each locality that is either lost, found or available for adoption. Generally, the pet information may be associated with an address or a zip code, which facilitates pairing potential owners with nearby pets. The pet may also be assigned an identification number by a shelter which is stored in the pet information database and the shelter itself may have an identification number that identifies it within the pet information database in connection with particular pets.

The user alert database is a relational database and includes information about users that are interested in adopting a pet, looking for a lost pet or reporting a found pet. In general, the alert database allows a user to register with the server 102, identify an email address and also devices through which the user desires to receive pet alerts. Each device may operate according to a different protocol. Accordingly, the database identifies the type of devices through which the user desires to receive pet alerts, such as a mobile phone 140 or other information device 145. The server then includes software that allows it to translate pet information from the pet information database to a format and a protocol suitable for each permitted device registered for a particular user.

For example, when the user selects a mobile device, the user information may include a mobile phone number and a mobile provider to properly configure a SMS message. When the user selects an email address or a text message, an email or text message may be generated, for example, by the mail function of PHP. When an alert application resident on the user's computer is selected, the user's computer may check a link on the website to determine from the link whether there is any information matching pet alert criteria.

The computers 120 and 125 may each be a server or other general purpose computer that runs computer programs. In general, the computers 120 and 125 are used to collect information on pets that have either been lost or found or that are being kept in a shelter for adoption and to upload the information to the pet information database 105. The pet information may include the type of pet, a photograph of the pet, the location of the pet, including by zip code, and any other pertinent detail about the pet including a description of the pet which may include, for example, its name, color, size, weight and health information, cost, and any other information desired. The information may be uploaded to the database 105 in any convenient manner including sending a file having pet information; sending information in email to a contact person who maintains the pet alert information server 102 and database 105; entering information directly into a webpage served by the server 102 or in any other convenient manner.

The telephones 130 may also be used as a source of pet information. For this purpose, a user may call a telephone number, such as 1-800-PETS911, to specify pet information. The pet information received over the telephones 130 may be taken by a person or an interactive voice response unit which prompts the user to enter pet information. This information in turn may be entered into the database 105 by operators in the case of live operators or, in the case of an IVR unit, may be sent to the pet information database 105 over the network 115.

The PSTN or other network 115 (and any other network described herein) may be a local area network, a wide area network, the public switched telephone network, the interconnected backbones, routers, bridges, switches and servers known as the Internet, other communications links and combinations thereof. The network may include direct electrical connections, wireless, optical or any other communications links, including analog, digital, circuit switched and packet switched, for transmitting information.

The user system 135 may be a general purpose computer system, a server, a personal digital assistant or any other device or hand held device that permits the exchange of information via the network 115 with the server 102. According to one embodiment of the invention, the user system 135 is a general purpose computer that executes computer software, including browser software, that permits the display of web pages generated by the server 102. The system 135 may also permit the exchange of information between the server 102 and input/output devices associated with the system 135. The user system 135 may be used by the user to sign up to receive alerts for particular types of animals in particular localities, for example by zip code; to report a lost or a found animal; to browse animals at area shelters; or to otherwise interact with information available from the server 102 and the associated databases.

FIG. 2 depicts a method of registering a user to receive pet alerts according to an embodiment of the present invention. Referring to FIG. 2, the user visits a web site and initiates the sign-up procedure 200. The user is then presented with a form in step 205 requesting login information, such as a user identification and a password. The form may also request an e-mail address. In step 210, a confirmation of registration request is sent to the e-mail address specified in step 205. If the user declines confirmation, either by active refusal or by neglecting to respond, the sign-up information provided for the user may expire, for example, after a period of time in step 220.

According to one embodiment of the invention, the user may confirm registration by selecting a link embedded in a confirmation email to the user. If the user selects the link, this confirms the user's registration in step 215 and may direct the user to a website where the user is presented with a form used to set up alert information for the user in step 225. The alert information may include, for example, a zip code (for regional searching), a county, a state, a city, or any other region that is capable of being identified from information within the pet information database 105. The alert information may further include one or more methods of notification and/or devices through which the user desires to receive alerts, for example, via e-mail, a text message to a cell phone, a message sent to a downloadable PC application, or the like.

The user may then be presented with a form in step 230 that allows the user to specify information about a pet for which the user is searching, information about the search and the locality within which the search is to take place for alerts. With respect to search information, the user may specify: that the user has lost a pet, that the user is interested in alerts about pets available for adoption, or that the user is interested in entering information about found animals or pets; the locality for the search, including where a found pet was found, where a lost pet was lost or the locality or localities from within which the user would prefer to adopt; an expiration for the search. In addition, the user may specify information about the lost, available or found pet, including the species of the pet; the location where and/or date when the pet was found; breed, color, gender, age or coat pattern; license/tag number; microchip number or any other identification code, device or information to facilitate identifying a pet. In all cases, entry of information may be accomplished in any convenient manner, including by selecting from a form available over the Internet that includes a list of options. For example, a form may be filled out to specify a set of attributes (i.e., searching for a black Labrador retriever that is less than 6 years old) in two zip codes that include the user's residence or otherwise are conveniently accessible by the user.

According to one embodiment of the invention, a user may select to receive a notification by the user's computer interacting with the server. If this is the case, in step 235, the user's computer may download a software application in step 240 via the network 115 from, for example, the server 102 or other convenient site. The software application may interact with the server 102 to generate alerts to the user of the computer when a pet search identifies matching pets on a periodic basis, such as hourly, or when the database 105 is updated. After step 240, step 245 begins. In step 245, at the end of the notification selection process, the user's alert preferences are saved 245 in the user alert database 110. This alert information is then used by the server 102 to conduct regular searches of the pet information database for each locality selected by the user to generate alerts for available pets, lost or found pets when search criteria are met, i.e. when the alert information matches the pet information.

FIG. 3 depicts a method of generating alerts according to an embodiment of the present invention. The alert process in general may be an automated process that initiates at specific times or at periodic intervals, for example, every thirty minutes. Alternatively, it may be asynchronous, or may be invoked in any other manner. In general, the alerts should be issued in a timely fashion, a relatively short period of time after an animal is described to the system and stored in the pet information database with information that matches an alert criteria.

Referring to FIG. 3, according to an embodiment of the present invention, a start signal is sent to begin the alert process 300. In step 305, the system then determines which users, if any, have active alert requests (i.e. are currently searching for a specific pet or type of pet, a lost pet, a found pet or a pet available for adoption). The search preferences of the user are extracted and converted into a database search query 310 for each search that has not yet expired, either by a date set by the user or a date set by the system (i.e. three months from date of lost pet or found pet). The results are then analyzed, and, in step 315 if no matches are found, the system moves on to the next active search. If a match is found in step 315, the user is notified in step 320 according to the notification method(s) specified by the user. In general, a match may be found when a pet available for adoption falls within the user's search criteria. A match may also be found when a lost pet falls within the description of a found or available pet.

In step 325, identifiers corresponding to “matched” pets are stored. When the user logs into the website, the user may be presented with a match access screen in step 330. The user may access the record of matches (for example, the abovementioned black Labrador retriever less than 6 years old), and may be presented with a set of options. In the case of lost/found pets the lost pet user may be presented with information about the person who found the pet to facilitate contact and the found pet user may be presented with information about the owner of the lost pet for the same purpose. The users may specify anonymity in the alert process and in that case, the lost or found pet users may exchange information through the system, via a telephone call to its operator, via the website, via email or in any other convenient manner. The user(s) may also update the status of the pet (i.e. change it from lost to found) or take the pet out of the system. The user may store the match in step 340, retaining its information while disabling future alerts regarding this specific match. The user may discard the match in step 345, disabling future alerts regarding this specific match. Or, lastly, the user may refine, alter or set up a new search in step 350 to either more accurately select among the presented matches or generate new results.

After the options in step 340-350 are taken, the alert process may terminate until invoked again. In this manner, pet alerts are generated based on up to date, real time information for information on local pets meeting particular criteria. This is useful for identifying lost and found pets in a locality to other users in the same locality and for facilitating adoption of pets. It is expected that the present system and method will reduce overcrowding in animal shelters and will help make adoptable pets presently in shelters more accessible and desirable to potential owners.

The following examples are illustrative of how the system and method work:

### EXAMPLE 1

A woman has lost her chocolate lab in upstate N.Y. She logs onto a website (www.PETS 911.com) and posts a description of her lost lab, desperately hoping that if someone has found her dog, they will check PETS 911 and see her listing and contact information. However, at the same time, she wants peace of mind by being alerted when any chocolate lab within a 30 mile radius of her home shows up as posted to PETS 911. Therefore, she chooses to be alerted via email, and with a text message sent to her cell phone. A day later, a man has found her lab, goes to PETS 911 because he knows about the PET ALERT and posts the dog. The woman is at a business lunch, but is right away alerted to a chocolate lab posted on the system. She contacts this number and is reunited with her dog!

### EXAMPLE 2

A man has a 6 year old little girl who would really like a little puppy. This man would like to get her a real family dog, perhaps a Golden Retriever that she can grow up with. He would like to rescue one, but so far, the shelters and rescues in his area don't have this particular breed available for adoption. So what he does is log on and opt in to receive a PET ALERT via email, as soon as a Golden Retriever matching his criteria is posted to the PETS 911 website. Four days later, the Golden Retriever Rescue in his area posts one to PETS 911 and he receives an email, gives them a call and adopts a beautiful dog.

While particular embodiments of the present invention have been illustrated and described herein, it will be understood that changes may be made to those embodiments without departing from the spirit and scope of the present invention. For example, it will be understood that the processes of FIGS. 2 and 3 may be implemented in computer program instructions that cause the server 102 to perform the steps indicated. In addition, the order of the steps shown may be changed in FIGS. 2 and 3.

What is claimed is:

1. A method for generating pet alerts, comprising:
storing pet information into a database corresponding to available pets;
creating alert criteria for a user corresponding to a desired pet; and
generating an alert transmitted to a device of the user when the desired pet is found in the pet information database.

2. The method as recited in claim 1, wherein the pet information further comprises information on the location of each pet stored in the database and wherein the alert criteria includes location information.

3. The method as recited in claim 2, wherein the generating automatically occurs at set intervals.

4. The method as recited in claims 4, wherein the device is equipped to receive the alert via e-mail.

5. The method as recited in claims 4, wherein the device is a mobile telephone.

6. The method as recited in claims 4, wherein the device is a computer.

7. A system for generating pet alerts, comprising:
a database accessible via a network that stores pet information about available pets and criteria for identifying particular kinds of pets;
a server coupled to the database allowing users to access the database to determine whether any pets are available that meet the criteria.
